(19) United States
(12) Patent Application Publication
(10) Pub. No.: US 2016/0283930 A1
(43) Pub. Date: Sep. 29, 2016

(54) DOCKING DEVICE, TRANSACTION PROCESSING SYSTEM AND NOTIFICATION METHOD

(71) Applicant: PANASONIC INTELLECTUAL PROPERTY MANAGEMENT CO., LTD., Osaka (JP)

(72) Inventor: Ichiro HAGA, Fukuoka (JP)

(73) Assignee: PANASONIC INTELLECTUAL PROPERTY MANAGEMENT CO., LTD., Osaka (JP)

(21) Appl. No.: 15/077,045

(22) Filed: Mar. 22, 2016

(30) Foreign Application Priority Data
Mar. 27, 2015 (JP) 2015-067322

(51) Int. Cl. G06Q 20/20; G06F 13/40; G06F 1/16

(52) U.S. Cl. CPC G06Q 20/206; G06F 1/1632; G06F 13/4081

(57) ABSTRACT

A docking device is capable of being attached to and detached from portable transaction equipment capable of executing at least one of a settlement application and a business application, and includes an equipment holder that holds the transaction equipment, an attachment detector that detects the attachment of the transaction equipment to the equipment holder; and a controller that performs a notification operation for notifying of the occurrence of a defect in a case where a predetermined alert generation condition is satisfied when the transaction equipment is detached from the equipment holder. A possibility that the notification for notifying of the occurrence of the defect will be detected is increased.

### BACKGROUND OF THE INVENTION

1. Field of the Invention

The present disclosure relates to a docking device connected to transaction equipment used to perform at least one procedure of a merchandise registration process and a settlement process in a commercial transaction, a transaction processing system including the docking device, and a notification method.

2. Description of the Related Art

In a store (for example, a convenience store), a merchandise registration process of registering merchandise items as sales targets in a commercial transaction (for example, merchandise sales, the same applies later) in a POS (Point Of Sales) terminal such as cash register is generally performed. For example, the POS terminal is a stationary type as in a POS terminal with a fixed scanner which is described in Japanese Patent Unexamined Publication No. 04-279995, and is fixedly provided in, for example, an exclusive counter of a store in many cases. In the POS terminal with a fixed scanner which is described in Japanese Patent Unexamined Publication No. 04-279995, a fixed scanner is supported by a supporting stand of the POS terminal through support means so as to be moved in upward and downward directions and forward, backward, leftward and rightward directions and so as to be tilted and rotated. In the merchandise registration process, a salesperson directly performs a touch input of merchandise items as sales targets on a touch panel provided at the POS terminal without using the fixed scanner, or performs a touch input of merchandise items displayed on a touch panel of portable transaction equipment in which an application for merchandise registration is installed so as to be executable in some cases.

For example, when a settlement process using a card (for example, a credit card) is performed in order to pay the amount of money required in the commercial transaction, in a case where an authorization inquiry about a owner of the card is performed and a response indicating that there are no particular problems with the authorization is obtained, the POS terminal transmits sales information to a settlement server (for example, a settlement center device operated by a settlement center or a settlement relay center device operated by a settlement relay center) connected to the POS terminal via a communication network (sales registration). In the settlement process, portable transaction equipment (for example, a settlement terminal) in which an application for a settlement process is installed so as to be executable and communication can be performed with the settlement server is used instead of the POS terminal in some cases.

For example, peripheral equipments such as a keyboard for inputting items or quantities of merchandises, a printer for printing a receipt related to the sales of the merchandises, a drawer for storing cash, and a display for displaying a sales amount of money to a customer are provided in, or are connected to the POS terminal provided in the store or near the POS terminal. Since the POS terminal is provided on the exclusive counter in the store, in order to improve operation convenience when the procedure of the merchandise registration process or the settlement process of the salesperson is performed, it is preferable to distinguish between a case where the portable transaction equipment and the peripheral equipment are used in cooperation with each other and a case where the transaction equipment is independently used.

The portable transaction equipment using an information processing terminal can be freely carried, and thus, this portable transaction equipment is convenient. However, there is a high risk of the loss, information leak or unauthorized operation unlike the stationary transaction equipment. In a case where the notification of the unauthorized operation is performed, it is difficult for a user (an employee of the store or a person in charge of the store) of the transaction processing system or a manager (a manger of the store or a manager of the settlement system) to detect the notification using the portable transaction equipment in some cases.

### SUMMARY OF THE INVENTION

An object of the present disclosure is to increase a possibility that the notification for notifying of the occurrence of a defect will be detected in a transaction processing system including a docking device capable of being attached to portable transaction equipment.

According to the present disclosure, there is provided a docking device that is capable of being attached to and detached from portable transaction equipment capable of executing at least one of a settlement application and a business application. The docking device includes: an equipment holder that holds the transaction equipment; an attachment detector that detects the attachment of the transaction equipment to the equipment holder; and a controller that performs a notification operation for notifying of the occurrence of a defect in a case where a predetermined alert generation condition is satisfied when the transaction equipment is detached from the equipment holder.

According to the present disclosure, there is provided a transaction processing system including: portable transaction equipment that is capable of executing at least one of a settlement application and a business application; and a docking device that is connected to at least one peripheral equipment used in the settlement application or the business application, and is capable of being attached to and detached from the transaction equipment. The docking device detects the attachment of the transaction equipment to an equipment holder that holds the transaction equipment by an attachment detector, and performs a notification operation for notifying of the occurrence of a defect in a case where a predetermined alert generation condition is satisfied when the transaction equipment is detached from the equipment holder.

According to the present disclosure, there is provided a notification method in a docking device capable of being attached to and detached from portable transaction equipment capable of executing at least one of a settlement application and a business application. The notification method includes: causing an attachment detector to detect the attachment of the transaction equipment to an equipment holder of the docking device which holds the transaction equipment; and performing a notification operation for notifying of the occurrence of a defect in a case where a predetermined alert generation condition is satisfied under the control of a controller when the transaction equipment is detached from the equipment holder.

According to the present disclosure, it is possible to increase a possibility that the notification for notifying of the occurrence of a defect will be detected in a transaction processing system including a docking device capable of being attached to portable transaction equipment.

### BRIEF DESCRIPTION OF DRAWINGS

FIG. 1 is a diagram showing an example of the system configuration of a transaction processing system of the present exemplary embodiment;

FIG. 2 is a diagram for describing an example of a state in which transaction equipment is attached to or is detached from a docking device;

FIG. 3 is a diagram showing an example of a state in which the transaction equipment is attached to the docking device;

FIG. 4A is a diagram showing an example of the docking device in which an upper supporting part is rotated around a lower supporting part through a hinge in a tilt direction (arrow v1 direction);

FIG. 4B is a diagram showing an example of the docking device in which a holder rotation part rotates an equipment holder in an arrow v2 direction about 90 degrees from the position in the state of FIG. 4A;

FIG. 4C is a diagram showing an example of the docking device in which a rotatable pedestal is rotated in a panning direction (arrow v3 direction) from the position in the state of FIG. 3;

FIG. 5 is a diagram showing an example of the hardware configuration of the transaction equipment of the present exemplary embodiment;

FIG. 6 is a diagram showing an example of the hardware configuration of the docking device of the present exemplary embodiment;

FIG. 7A is a diagram showing a first example in which an operation screen of a card settlement application executable in the transaction equipment is displayed on a touch panel of the transaction equipment;

FIG. 7B is a diagram showing a second example in which the operation screen of the card settlement application executable in the transaction equipment is displayed on the touch panel of the transaction equipment;

FIG. 8 is a diagram showing an example in which a screen of a merchandise registration application executable in the transaction equipment is displayed on the touch panel of the transaction equipment;

FIG. 9 is a flowchart for describing an example of a process of a notification operation in the docking device of the present exemplary embodiment; and

FIG. 10 is a diagram showing an example of an alert indication displayed on an external display or the transaction equipment.

### DETAILED DESCRIPTION OF THE PREFERRED EMBODIMENT

Hereinafter, an exemplary embodiment (hereinafter, referred to as “present exemplary embodiment”) in which a transaction processing system, a docking device and a notification method according to the present disclosure are specifically disclosed will be described in detail by appropriately referring to the drawings. Unnecessary descriptions may be omitted in some cases. For example, the detailed descriptions of the already well-known matters or the redundant descriptions of substantially the same configurations may be omitted in some cases. Such omissions are performed in order to allow a person skilled in the art to easily understand the present disclosure by preventing the following description from becoming unnecessarily redundant. The accompanying drawings and the following descriptions are provided to help a person skilled in the art fully understand the present disclosure, and thereby are not intended to limit the subject matter described in the claims.

### System Configuration of Transaction Processing System

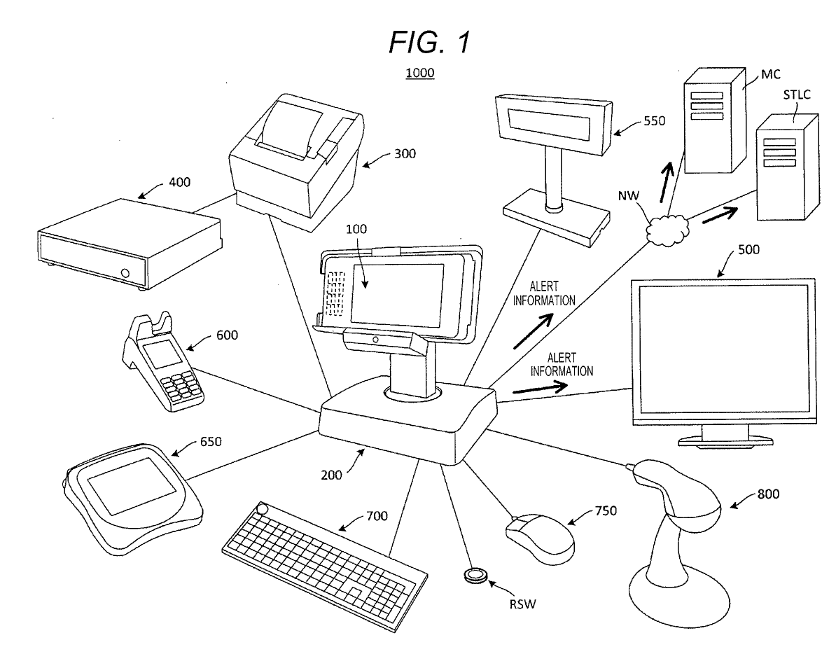

Initially, the system configuration of transaction processing system 1000 of the present exemplary embodiment will be described with reference to FIG. 1. FIG. 1 is a diagram showing an example of the system configuration of transaction processing system 1000 of the present exemplary embodiment. For example, transaction processing system 1000 shown in FIG. 1 is provided in a store such as a convenience store or a supermarket, and includes transaction equipment 100, docking device 200, receipt printer 300, cash drawer 400, external display 500, customer display 550, PINPAD 600, sign pad 650, keyboard 700, mouse 750, and barcode reader 800. Hereinafter, at least one of receipt printer 300, cash drawer 400, external display 500, customer display 550, PINPAD 600, sign pad 650, keyboard 700, mouse 750, and barcode reader 800 is referred to as “peripheral equipment” in some cases.

In transaction processing system 1000, docking device 200 on which transaction equipment 100 is mounted is connected to a settlement server (for example, a settlement relay center device operated by third party processor or a settlement center device operated by an issuer or an acquirer, to be described below) STLC in a settlement application which is installed to be executable in transaction equipment 100 via network NW.

Docking device 200 is connected to monitoring center device MC through network NW. Monitoring center device MC monitors the operations of the respective devices of transaction processing system 1000, receives alert information from docking device 200, and detects the occurrence of defects such as the unauthorized use of transaction equipment 100.

Network NW is, for example, an intranet or the Internet. For example, the intranet is a wireless or wired local area network within the store in which transaction equipment 100 is provided. The internet is a network connected using the wireless network or the wired network as an interface. For example, the wireless network is a wireless LAN (Local Area Network), a wireless WAN (Wide Area Network), 3G, HSPA (High Speed Packet Access), LTE (Long Term Evolution), or WiGig (Wireless Gigabit). For example, the wired network is IEEE802.3/Ethernet (registered trademark). For example, network NW may be a wide area network established using 3G, HSPA or LTE, or may be a network established using an existing telephone line. Network NW may be established using another connection network such as an internet connection network through an access point which is a spot of Wifi (registered trademark). The Internet may be established using another connection network such as a dedicated line or an intranet.

The settlement relay center device is a server device for a settlement relay process in a third party processor (that is, a company which is requested a business from an issuer (a card issuing company) or an acquirer (a company that invites member stores which specific card transaction, and manages sales information based on the card transaction of the member store), and relays a settlement process from each member store). The settlement relay center device receives a request for sales registration or an authorization inquiry for the settlement process of a commercial transaction from transaction equipment 100 via network NW, inquires about the determination of whether or not to grant authorization by the settlement center device, and requests the processing of the sales registration by the settlement center device.

For example, settlement center device STLC2 is a server device for a settlement process which is operated by the issuer or the acquirer that directly fulfills member-store contracts with the member stores. The settlement center device sends the authorization result, the determination result of the authorization inquiry or the processing result of the sales registration to transaction equipment 100 through the settlement relay center device in response to the inquiry about the determination from the settlement relay center device. Settlement center device STLC2 may receive a request for the sales registration or the authorization inquiry of the settlement process of the commercial transaction from transaction equipment 100 via network NW, may perform the determination of whether or not to authorize, and may directly send the processing result of the sales registration or the determination result of the authorization inquiry to transaction equipment 100.

For example, transaction equipment 100 is a settlement terminal device, such as a tablet terminal which is easily held with one hand or both hands, which includes a portable housing and in which at least one of a settlement application and a general-purpose business application (for example, a merchandise registration application or a stock management application) required for the business in the store where transaction equipment 100 is provided is installed so as to be executable. Hereinafter, the transaction equipment may be referred to as MPOS (Mobile Point Of Sales) in some cases. Transaction equipment 100 receives information (settlement information) regarding various items related to the settlement process of a transaction using a card through touch panels TP2 and TP1 by a user (for example, a salesperson or a customer), and reads a card number and an expiration date of the card.

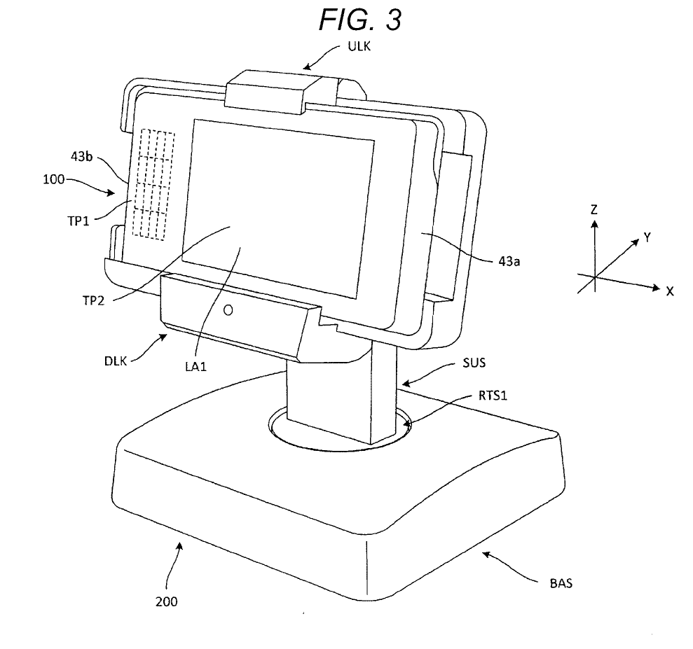

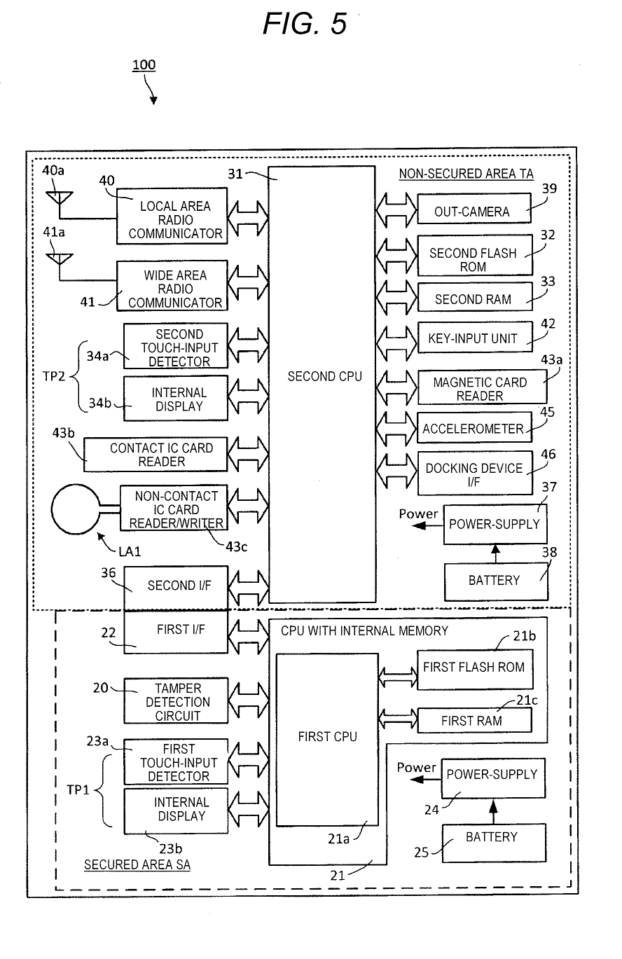

In a case where transaction equipment is attached to docking device 200 (see FIG. 3), transaction equipment (MPOS) 100 performs communication related to the settlement process of the commercial transaction using the card (for example, an IC credit card. The same applies later) with settlement server STLC (for example, the settlement relay center device or the settlement center device) via docking device 200 and network NW. Even in a case where transaction equipment is detached from docking device 200, transaction equipment 100 may perform the communication related to the settlement process of the commercial transaction using the card with settlement server STLC via the network. The specific configuration of transaction equipment 100 will be described with reference to FIG. 5.

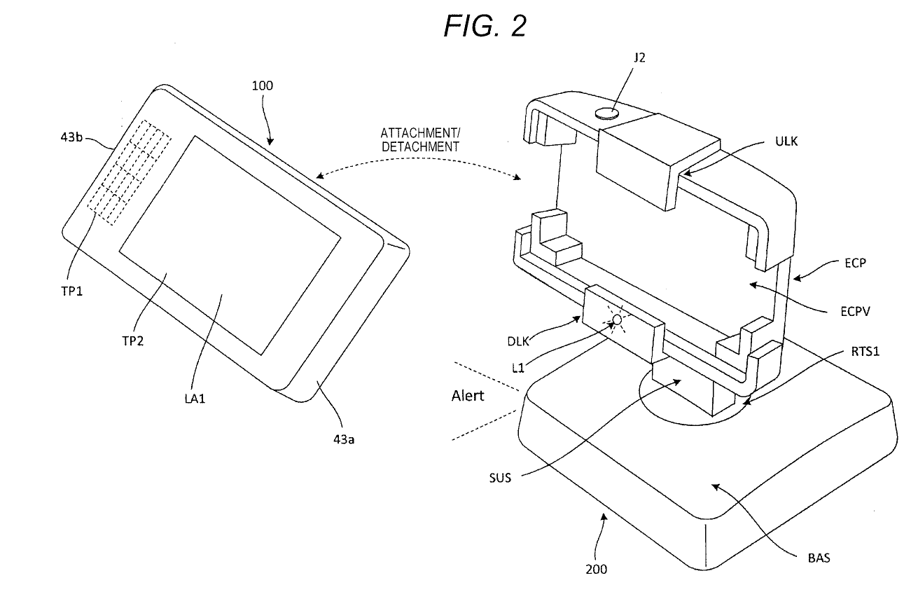

Docking device 200 is connected to at least one peripheral equipment (see FIG. 1) used in at least one of the settlement application and the general-purpose application installed in transaction equipment 100, and allows transaction equipment 100 to be attached and detached (see FIGS. 2 and 3).

Receipt printer 300 as an example of the peripheral equipment is connected to docking device 200 and cash drawer 400, and prints predetermined receipts by using print data regarding the predetermined receipts (for example, a customer receipt and a store receipt) output from docking device 200 in a case where the settlement related to the commercial transaction is normally ended. For example, in a case where the receipts are printed, receipt printer 300 switches a switch built in cash drawer 400 from an OFF state (a locked state) to an ON state (an unlocked state), and pushes cash drawer 400 in an opening direction, in response to a control signal from transaction equipment 100. In a case where transaction equipment 100 is attached to and is connected to docking device 200, the control signal is a signal which is transmitted from transaction equipment 100 and is received by docking device 200, and is transmitted to receipt printer 300 through docking device 200.

Cash drawer 400 as an example of the peripheral equipment is connected to only receipt printer 300, and strictly stores cash possessed in the store where transaction processing system 1000 is provided.

External display 500 as an example of the peripheral equipment is a display device which is connected to docking device 200 and has a display area greater than that of internal display 34b of transaction equipment 100. External display 500 may be a touch panel capable of detecting a touch input of the salesperson or the customer.

Customer display 550 as an example of the peripheral equipment is a display device which is connected to docking device 200 and has a display area having a predetermined size, and displays, for example, a sales amount of money (settlement amount of money) related to the commercial transaction of the customer in a direction in which the information can be easily seen by the customer. Customer display 550 may be a touch panel capable of detecting a touch panel of the salesperson or the customer.

PINPAD 600 as an example of the peripheral equipment is an input device which is connected to docking device 200 and allows the customer to input a PIN (Personal Identification Number) as authentication information for authenticating the customer as a legitimate owner of the card during the execution of the settlement application using the card.

Sign pad 650 as an example of the peripheral equipment is an input device which is connected to docking device 200 and allows the customer to input electronic data regarding a handwritten signature as authentication information for authenticating the customer as a legitimate owner of the card during the execution of the settlement application using the card.

Keyboard 700 as an example of the peripheral equipment is connected to docking device 200, and is used by the salesperson in order to input characters or numerals on an operation screen of an application executable in transaction equipment 100.

Mouse 750 as an example of the peripheral equipment is connected to docking device 200, and is used by the salesperson in order to select a specific item on an operation screen of an application executable in transaction equipment 100.

Barcode reader 800 as an example of the peripheral equipment is connected to docking device 200, and is used by the salesperson in order to read a barcode assigned to a merchandise or a coupon as a target of the commercial transaction.

Rubbery notification button RSW is connected to docking device 200. Rubbery notification button RSW is a switch pushed when a user such as a salesperson notifies a police officer and monitoring center device MC at the time of the rubbery, and an operation state is detected by docking device 200. Attachment and Detachment of Transaction Equipment to and from Docking Device

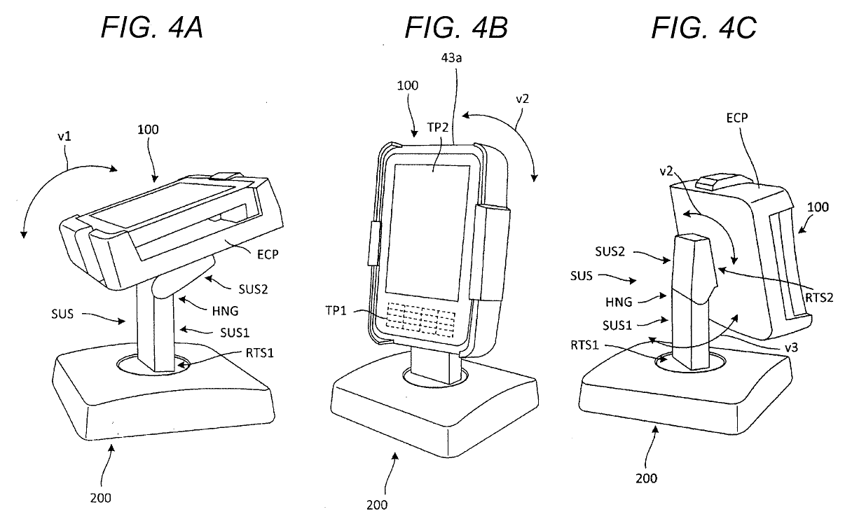

Hereinafter, the attachment and detachment of transaction equipment 100 to and from docking device 200 will be described with reference to FIGS. 2, 3, and 4A to 4C. FIG. 2 is a diagram for describing an example of a state in which transaction equipment 100 is attached to and is detached from docking device 200. FIG. 3 is a diagram showing an example of a state in which transaction equipment 100 is attached to docking device 200. FIG. 4A is a diagram showing an example of docking device 200 in which upper supporting part SUS2 is rotated around lower supporting part SUS1 in a tilt direction (arrow v1 direction) through hinge HNG. FIG. 4B is a diagram showing docking device 200 in which holder rotation part RTS2 rotates equipment holder ECP in an arrow v2 direction about 90 degrees from the position in the state of FIG. 4A. FIG. 4C is a diagram showing an example of docking device 200 in which rotatable pedestal RTS1 is rotated in a panning direction (arrow v3 direction) from the position in the state of FIG. 3.

For example, docking device 200 is disposed in a predetermined position of a checkout counter of the store, and includes equipment holder ECP supported by supporting part SUS which is erected upward from columnar rotatable pedestal RTS1, which is provided in a near central position of square-columnar fixing pedestal BAS, in a vertical direction. Rotatable pedestal RTS1 is rotated around fixing pedestal BAS about 180 degrees (see FIG. 4C). Equipment holder ECP includes upper locking part ULK, and lower locking part DLK, and holds and locks transaction equipment 100 in equipment holding space ECPV formed between upper locking part ULK and lower locking part DLK so as to expose transaction equipment 100. Locking part J2 is formed in upper locking part ULK, and if transaction equipment 100 is attached in equipment holding space ECPV of docking device 200 and then is locked by a tool such as a driver, upper locking part ULK and lower locking part DLK lock transaction equipment 100 so as to sandwich transaction equipment in both directions of an upward direction and a downward direction. Thus, transaction equipment 100 is physically attached to docking device 200.

Docking device 200 includes, for example, LED (Light Emitting Diode) lamp L1 that displays an alert on upper locking part ULK of equipment holder ECP (see FIG. 2). Docking device 200 includes a speaker that produces alert sound.

In the case where the transaction equipment is attached to docking device 200 (see FIG. 3) and in the case where the transaction equipment is detached from the docking device (see FIG. 2), for example, transaction equipment 100 can receive an input operation of the salesperson on touch panel TP2 provided in non-secured area TA (see FIG. 5), and can receive an input operation of the customer on touch panel TP1 provided in secured area SA (see FIG. 5).

In transaction equipment 100, magnetic card reader 43a is provided on a side surface of the housing of transaction equipment 100 close to non-secured area TA, in a transverse direction, and contact IC card reader 43b is provided on a side surface of the housing of transaction equipment 100 close to secured area SA. Loop antenna LA1 connected to non-contact IC card reader/writer 43c, to be described below, is provided in a portion of the housing of transaction equipment 100 close to non-secured area TA (that is, a portion which is substantially parallel to touch panel TP2). In the case where the transaction equipment is attached to docking device 200 (see FIG. 3) and in the case where the transaction equipment is detached from the docking device (see FIG. 2), transaction equipment 100 can read a magnetic card in magnetic card reader 43a, can read a contact IC card in contact IC card reader 43b, and can read a non-contact IC card approaching near loop antenna LA1 in non-contact IC card reader/writer 43c through the operation of the salesperson.

As shown in FIGS. 4A to 4C, docking device 200 to which transaction equipment 100 is attached can be rotated in various directions. For example, as shown in FIG. 4A, in docking device 200, upper supporting part SUS2 can be rotated around lower supporting part SUS1 through hinge HNG in the tilt direction (arrow v1 direction). Supporting part SUS shown in FIG. 2 or 3 is configured such that lower supporting part SUS1 lower supporting part SUS1 which is erected from rotatable pedestal RTS1, hinge HNG which rotates upper supporting part SUS2 around lower supporting SUS1 in the tilt direction, and upper supporting part SUS2 which supports equipment holder ECP are sequentially connected (see FIG. 4A). Thus, the salesperson or the customer can easily input the operations on touch panels TP2 and TP1 by rotating docking device 200 such that touch panels TP2 and TP1 of transaction equipment 100 face a ceiling surface of the store.

As shown in FIG. 4B, in docking device 200, holder rotation part RTS2 (see FIG. 4C) can rotate equipment holder ECP in the arrow v2 direction about 90 degrees from the position in the state of FIG. 4A. Thus, since the salesperson or the customer can rotate touch panels TP2 and TP1 of transaction equipment 100 such that the longitudinal direction of the housing of transaction equipment 100 is parallel to the vertical direction, the salesperson or the customer can easily see the operation screen of the application including characters or numerals displayed on touch panels TP2 and TP1, and can easily operate the operation screen.

As shown in FIG. 4C, in docking device 200, rotatable pedestal RTS1 can be rotated in the panning direction (arrow v3 direction) from the position in the state of FIG. 3 (that is, a state in which transaction equipment 100 is attached to docking device 200). Thus, since the salesperson can turn the operation screen of the application displayed on touch panel TP2 of transaction equipment 100 toward the salesperson or the customer, the salesperson and the customer facing the salesperson can simply perform the operation on touch panel TP2.

### Configuration of Transaction Equipment

Hereinafter, the hardware configuration of transaction equipment 100 of the present exemplary embodiment will be described with reference to FIG. 5. FIG. 5 is a diagram showing an example of the hardware configuration of transaction equipment 100 of the present exemplary embodiment. Transaction equipment 100 shown in FIG. 5 has non-secured area TA and secured area SA. “Secure” mentioned herein means that the area has tamper resistance. “Non-secure” means that the area has no tamper resistance. “Tamper resistance” refers to resistance to illegal analysis and modification of software or hardware within equipment, illegal piracy and modification, of information within the equipment, and attack to allow the information to be disabled. That is, the tamper resistance refers to the difficulty of analyzing stored data or the internal structure of the hardware or the software. The area has the tramper resistance, and thus, information of a service receiver (for example, the customer) can be protected and the transaction can be safely performed.

In secured area SA, tamper detection circuit 20 that detects whether or not a physical unauthorized behavior (for example, breakage and damage of transaction equipment 100) is performed, CPU 21 with internal memory, first I/F (interface) 22, first touch-input detector 23a, internal display 23b, power-supply 24, and battery 25 are provided. First touch-input detector 23a and internal display 23b constitute touch panel TP1. In CPU 21 with internal memory, first CPU 21a, first flash ROM (Read Only Memory) 21b, and first RAM (Random Access Memory) 21c are provided.

In secured area SA, various components are electrically and logically connected to first CPU 21a. First CPU 21a manages all the components in secured area SA. For example, first CPU 21a performs various controls, processes, settings, determinations, checks, authentications, inquires (for example, an inquiry about PIN or signature), and instructions by executing programs stored in first flash ROM 21b.

First flash ROM 21b stores an encryption key used in communication with settlement server STLC (see FIG. 1, for example, the settlement relay center device or the settlement center device), personal information such as a PIN, confidential information such as settlement information regarding the settlement, or programs for transaction equipment 100 to receive a PIN input and an inquiry of the settlement. First flash ROM 21b is an example of a storage medium that stores programs and data for information processing in first CPU 21a.

For example, when processes associated with the reception of the PIN input and the inquiry of the settlement of transaction equipment 100 (for example, secured area SA) are performed, first RAM 21c is a work memory used to temporarily store processing data generated during the process.

Tamper detection circuit 20 constantly monitors secured area SA, and detects the physical unauthorized behavior (for example, the analysis. breakage or unsealing of secured area SA of transaction equipment 100) of secured area SA. In other words, tamper detection circuit 20 detects whether or not abnormality occurs in secured area SA. In a case where an event of the physical unauthorized behavior is detected by tamper detection circuit 20, CPU 21 with internal memory or second CPU 31 may forcibly stop the settlement process in the settlement application, or may notify that the physical unauthorized behavior is detected in secured area SA through at least one of touch panels TP1 and TP2.

First I/F 22 is provided to electrically connect non-secured area TA to secured area SA, and delivers various data items or commands between non-secured area TA and secured area SA through second I/F 36. First I/F 22 and second I/F 36 can be coupled to each other.

First touch-input detector 23a detects the touch input of the salesperson or the customer on touch panel TP1. For example, first touch-input detector 23a may detect an input on a PIN pad as a physical keypad or a software keyboard for inputting the PIN. For example, first touch-input detector 23a may detect a signature input using a finger or a stylus pen. For example, first touch-input detector 23a may detect a handwritten input of the PIN by using a finger or a stylus pen.

For example, internal display 23b is a LCD (Liquid Crystal Display) or an organic EL (Electroluminescence), and displays, for example, predetermined data (for example, numeric keys) for inputting the authentication information (for example, the PIN or signature) of the customer in the settlement application. Data displayed on internal display 23b is not limited to the numeric keys.

Power-supply 24 is a power supply of secured area SA, receives power from battery 25, and supplies power to secured area SA (for example, first CPU 21a). First CPU 21a can supply the power and stop the supply of the power to a part or all of the circuits arranged in secured area SA by controlling power-supply 24.

In non-secured area TA, second CPU 31, second flash ROM 32, second RAM 33, second touch-input detector 34a, internal display 34b as an example of a display unit, second I/F 36, power-supply 37, battery 38, out-camera 39, local area radio communicator 40 to which local area radio antenna 40a is connected, wide area radio communicator 41 to which wide area radio antenna 41a is connected, key-input unit 42, magnetic card reader 43a, contact IC card reader 43b, non-contact IC card reader/writer 43c to which loop antenna LA1 is connected, accelerometer 45, and docking device I/F 46 are provided. Second touch-input detector 34a and internal display 34b constitute touch panel TP2.

In non-secured area TA, various components are electrically and logically connected to second CPU 31. Second CPU 31 manages all the components in non-secured area TA. For example, second CPU 31 performs various controls, processes, settings, determinations and instructions by executing programs stored in second flash ROM 32. Second CPU 31 starts and executes various applications stored in second flash ROM 32, and pauses or ends the execution in response to the operation of the salesperson.

Second flash ROM 32 stores various data items and programs. The stored data and program are a program and data used in the settlement application and the business application (for example, a merchandise registration application, a stock management application, a document creation application used on a daily basis, and a spread sheet application), and may be a program for controlling transaction equipment 100 (for example, non-secured area TA). Accordingly, second flash ROM 32 is an example of a storage medium that stores programs and data for information processing in second CPU 31.

For example, when processes associated with the operations of transaction equipment 100 (for example, the components in non-secured area TA) are performed, second RAM 33 is a work memory used to temporarily store processing data generated during the process.

Second touch-input detector 34a detects the touch input of the salesperson or the customer on touch panel TP2. For example, second touch-input detector 34a detects the input on the operation screen of at least one of the settlement application and the business application (for example, the merchandise registration application) displayed on touch panel TP2.

Internal display 34b is, for example, a LCD (Liquid Crystal Display) or an organic EL (Electroluminescence), and displays data regarding the operation screen for inputting various information items (for example, a card brand, a card number, an expiration date, an amount of money, a payment method, and the number of payments) related to the settlement process using the card in, for example, the settlement application, or displays data regarding the operation screen for inputting the quantities or items of merchandises as a sales target in the merchandise registration application. The size of the display area of internal display 34b is less than the size of the display area of external display 500. In other words, even though the operation screens of the same application are considered, the operation screen displayed on external display 500 is larger than the operation screen displayed on internal display 34b, and thus, the salesperson or the customer can easily see the screens.

Second I/F 36 is provided to electrically connect non-secured area TA to secured area SA, and delivers various data items and commands between non-secured area TA and secured area SA through first I/F 22. First I/F 22 and second I/F 36 can be coupled to each other.

Power-supply 37 is a power supply of non-secured area TA, and receives power from battery 38, and supplies power to non-secured area TA (for example, second CPU 31). Second CPU 31 can supply the power and stop the supply of the power to a part or all of the circuits arranged in non-secured area TA by controlling power-supply 37.

Out-camera 39 is a camera provided such that a lens is exposed from the housing of transaction equipment 100, and obtains image data by capturing an image of light in a range in which the light is incident on the lens in response to the operation on key-input unit 42 or touch panel TP2, for example.

Local area radio communicator 40 is connected to local area radio antenna 40a, and performs communication using, for example, a wireless LAN by using local area radio communication path. Local area radio communicator 40 may perform communication (for example, communication using Bluetooth (registered trademark)) other than wireless LAN communication.

Wide area radio communicator 41 is connected to wide area radio antenna 41a, and performs communication using a wide area radio communication path (for example, a WAN (Wide Area Network)). The communication in the wide area radio communication path may be performed using, for example, a radio telephone network (a cellular network (W-CDMA (Wideband Code Division Multiple Access), CDMA (Code Division Multiple Access) 2000, or LTE (Long Term Evolution)).

For example, in a case where various buttons are provided on the housing of transaction equipment 100, key-input unit 42 receives push operations of various buttons. In a case where various buttons are not provided on the housing of transaction equipment 100, key-input unit 42 may be omitted from the configuration of transaction equipment 100.

Magnetic card reader 43a is provided on a side surface of the housing of transaction equipment 100 close to non-secured area TA in the transverse direction (see FIG. 3), is provided with a slit which is formed in the side surface and through which a swipe operation is performed in a state in which the salesperson holds the magnetic card, and reads a magnetic stripe of the magnetic card in response to the swipe operation. Information regarding the magnetic stripe read by magnetic card reader 43a is input to second CPU 31.

Contact IC card reader 43b is disposed within an insertion hole of the contact IC card which is formed in the side surface of the housing of transaction equipment 100 close to secured area SA in the transverse direction (see FIG. 3), and reads card information registered in a chip within the contact IC card through an electrode of the contact IC card (for example, an IC credit card) inserted into the insertion hole. The card information read by contact IC card reader 43b is input to second CPU 31.

Non-contact IC card reader 43c is connected to loop antenna LA1 disposed in a portion of the housing of transaction equipment 100 close to non-secured area TA (that is, a portion which is substantially parallel to touch panel TP2), performs radio communication with the card (for example, the IC credit card) in a non-contact manner using NFC (Near Field Communication), and reads or writes the card information registered in the card. The card information read by non-contact IC card reader/writer 43c is input to second CPU 31. Non-contact IC card reader/writer 43c may regularly authenticate with respect to non-contact reader/writer 71 of docking device 200 whether or not the transaction equipment is electrically connected to docking device 200 through communication between loop antenna LA1 of transaction equipment 100 and loop antenna LA2 of docking device 200.

Magnetic card reader 43a, contact IC card reader 43b, and non-contact IC card reader/writer 43c which are provided in non-secured area TA may be connected to first CPU 21a present in secured area SA.

Accelerometer 45 detects accelerations in an X-axis direction, a Y-axis direction and a Z-axis direction (see three-axis direction shown in FIG. 3) of transaction equipment 100, and outputs the detection result to second CPU 31. Accelerometer 45 can detect a gravity direction (a vertically downward direction, that is, a −Z-axis direction) of transaction equipment 100.

Docking device I/F 46 as an example of an authentication controller performs a regular inquiry (for example, a challenge response process to be described below) about the determination of whether or not transaction equipment 100 and docking device 200 are electrically connected with respect to device authentication controller 63 (to be described below) of docking device 200 through a connector.

As described above, transaction equipment 100 includes secured area SA and non-secured area TA. A “secured” portion requiring “tamper resistance” in transaction equipment 100 during the execution of various applications is localized to secured area SA. Meanwhile, many information processing devices (for example, smartphones or tablet terminals) distributed as devices for consumers or some devices thereof are used in non-secured area TA, as a general-purpose platform.

By using the general-purpose platform in non-secured area TA, development resources of the settlement application and the business application are easily reduced or applied. The settlement application and the business application are flexibly operated without stress by being processed by second CPU 31 of non-secured area TA having, for example, high arithmetic processing ability. Since various settlement application or business applications in which settlement schemes are diversified can be easily used, these applications can be installed in transaction equipment 100.

### Configuration of Docking Device

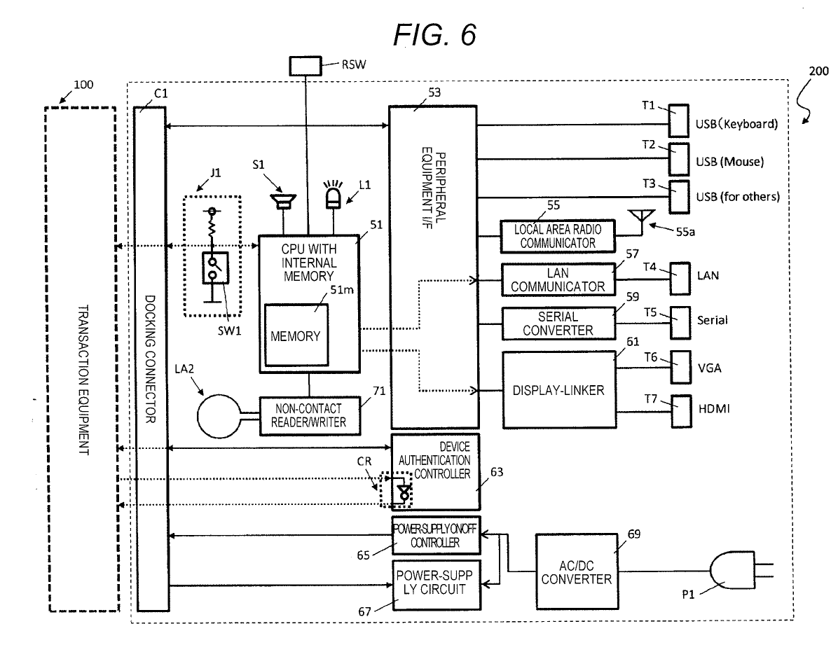

Hereinafter, the hardware configuration of docking device 200 of the present exemplary embodiment will be described with reference to FIG. 6. FIG. 6 is a diagram showing an example of the hardware configuration of docking device 200 of the present exemplary embodiment. In FIG. 6, transaction equipment 100 is also illustrated in order to conveniently describe the operation of docking device 200. Docking device 200 shown in FIG. 6 includes CPU 51 with internal memory, peripheral equipment I/F 53, local area radio communicator 55 to which local area radio antenna 55a is connected, LAN communicator 57, serial converter 59, display-linker 61, device authentication controller 63, power-supply on/off controller 65, power-supply circuit 67, AC/DC converter 69 to which power plug P1 is connected, non-contact reader/writer 71 to which loop antenna LA2 is connected, lock determination part J1, docking connector C1, speaker S1, and LED (Light Emitting Diode) lamp L1.

CPU 51 with internal memory as an example of a controller includes memory 51m, and manages all the components in docking device 200. For example, CPU 51 with internal memory performs various controls, processes, settings, determinations, authentications, checks, inquiries and instructions by executing programs stored in memory 51m.

Memory 51m stores various programs and data required for the operation of docking device 200, and functions as a work memory which temporarily stores processing data generated during the operation of CPU 51 with internal memory.

Peripheral equipment I/F 53 delivers data with respect to various peripheral equipments (see FIG. 1) connected to various terminals (terminals T1, T2, T3, T4, T5, T6 and T7) in a direct manner or in an indirect manner through LAN communicator 57, serial converter 59 and display-linker 61. Terminals T1, T2 and T3 are directly connected to peripheral equipment I/F 53. Keyboard 700 is connected to terminal T1. Mouse 750 is connected to terminal T2. Other peripheral equipments (for example, PINPAD 600, sign pad 650, and barcode reader 800) are connected to terminal T3.

Local area radio communicator 55 is connected to local area radio antenna 55a, and performs communication using, for example, a wireless LAN by using a local area radio communication path. Local area radio communicator 55 may perform communication (for example, communication using Bluetooth (registered trademark)) other than wireless LAN communication.

LAN communicator 57 is connected to terminal T4, is connected to a local network (for example, an intranet of the store) through terminal T4, and performs transmission and reception of data with the network. For example, the intranet of the store is connected to terminal T4.

Serial converter 59 is connected to terminal T5, performs serial-to-parallel conversion of data, and performs the transmission of print data of the predetermined receipts (for example, the customer receipt and the store receipt) transmitted from transaction equipment 100 or the reception of a print completion notification of the print data transmitted from receipt printer 300 with respect to receipt printer 300 connected to terminal T5. Serial converter 59 transmits a control signal for pushing cash drawer 400 in the opening direction to cash drawer 400 through receipt printer 300. Receipt printer 300 is connected to terminal T5.

Display-linker 61 is connected to terminals T6 and T7, and delivers data regarding at least one operation screen of the settlement application and the business application transmitted from transaction equipment 100 to external display 500 or customer display 550 connected to terminals T6 and T7. External display 500 or customer display 550 capable of handling data corresponding to VGA (Video Graphical Array) is connected to terminal T6. External display 500 or customer display 550 capable of handling data corresponding to HDMI (High-Definition Multimedia Interface) (registered trademark) is connected to terminal T7.

Device authentication controller 63 includes, for example, challenge response controller CR, and regularly performs a challenge response process as an authentication method for authenticating whether or not transaction equipment 100 and docking device 200 are correctly connected. In the challenge response process, challenge data is sequentially delivered to challenge response controller CR, docking connector C1, the connector of transaction equipment 100, docking device I/F 46, and second CPU 31, and response data is sequentially delivered to second CPU 31, docking device I/F 46, the connector of transaction equipment 100, docking connector C1, and challenge response controller CR. In a case where correct response data is obtained as the processing result of challenge response controller CR, device authentication controller 63 determines that transaction equipment 100 is correctly attached to and is connected to docking device 200.

Power-supply on/off controller 65 receives a part of a DC power obtained by converting (for example, rectification and smoothing) a commercial power supply (power) supplied to power plug P1 in AC/DC converter 69 and determines whether or not to supply the DC power to transaction equipment 100 through docking connector C1. The commercial power supply is constantly supplied to docking device 200 through power plug P1. However, since only batteries 25 and 38 are provided in transaction equipment 100, in a case where it is determined that the remaining capacity of batteries 25 and 38 of transaction equipment 100 is less than a predetermined value, power-supply on/off controller 65 can supply the power to transaction equipment 100. In other words, if the transaction equipment is attached to and is connected to docking device 200, transaction equipment 100 can charge batteries 25 and 38.

Power-supply circuit 67 supplies power supplies (powers) that are suitable for various components for operating the various components of docking device 200 by using a part of the DC power obtained by performing conversion (for example, rectification and smoothing) in AC/DC converter 69.

Non-contact reader/writer 71 is connected to loop antenna LA2, and regularly authenticates whether or not the docking device is electrically connected to transaction equipment 100 with respect to non-contact IC card reader/writer 43c of transaction equipment 100 through communication between loop antenna LA2 and loop antenna LA1 of transaction equipment 100.

Locking determination part J1 includes switch SW1, and determines whether or not transaction equipment 100 is physically attached to and is fixed to docking device 200. Specifically, in a case where the housing of transaction equipment 100 is held in and is attached to equipment holder ECP of docking device 200 and locking part J2 is fixed through a tool such as a driver, switch SW1 is turned on, and thus, locking determination part J1 determines that transaction equipment 100 is physically attached to and is fixed to docking device 200. Meanwhile, in a case where the housing of transaction equipment 100 is not held in equipment holding space ECPV of docking device 200, or in a case where the housing of the transaction equipment is held in and is attached to equipment holding space and locking part J2 is not fixed through the tool such as the driver, switch SW1 is turned off, and thus, locking determination part. J1 determines that transaction equipment 100 is not physically fixed to docking device 200. Although it has been described that the ON and OFF of switch SW1 and the attachment and detachment of transaction equipment 100 to and from docking device 200 correspond to each other, and vice versa. In other words, in a case where switch SW1 is turned off, transaction equipment 100 may be physically fixed to docking device 200, and in a case where switch SW1 is turned on, transaction equipment 100 may not be physically fixed to docking device 200.

In the present exemplary embodiment, in docking device 200, device authentication controller 63 and lock determination part J1 achieve the functions of an attachment detector. Here, by performing the determination through at least one of device authentication controller 63 and lock determination part J1, the attachment or detachment of transaction equipment 100 to equipment holder ECP of docking device 200 is detected.

In a case where the housing of transaction equipment 100 is held in and is attached to equipment holder ECP of docking device 200, docking connector C1 electrically connects transaction equipment 100 and docking device 200.

CPU 51 with internal memory is a controller, has a function of performing a notification operation such as an alert, and performs the notification operation in a case where a predetermined alert generation condition to be described below is satisfied. As an example of the notification operation, CPU 51 with internal memory transmits alert information to external display 500, transaction equipment 100 and monitoring center device MC through display-linker 61, docking connector C1, LAN communicator 57 or local area radio communicator 55.

In a case where the predetermined alert generation condition is satisfied, speaker S1 outputs an alert sound having a predetermined volume in response to an instruction of CPU 51 with internal memory.

LED lamp L1 can emit light of a LED, and emits light of predetermined color (for example, blinking of red color) as an alert indication in response to an instruction of CPU 51 with internal memory in a case where the predetermined alert generation condition is satisfied.

Docking device 200 is connected to rubbery notification button RSW, and detects an operation state of rubbery notification button RSW by CPU 51 with internal memory. In a case where rubbery notification button RSW is pushed, CPU 51 with internal memory transmits alert information notifying of the occurrence of rubbery to an external device such as monitoring center device MC through LAN communicator 57 or local area radio communicator 55 via the network.

### Example of Operation Screen of Settlement Application

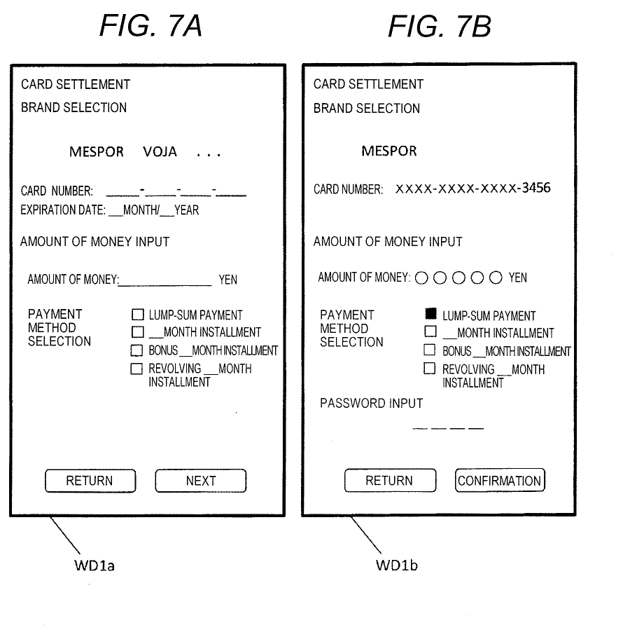

Hereinafter, the operation screen of the settlement application (for example, a card settlement application) installed in transaction equipment 100 will be described with reference to FIGS. 7A and 7B. FIG. 7A is a diagram showing a first example in which operation screen WD1a of the card settlement application executable in transaction equipment 100 is displayed on touch panel TP2 of transaction equipment 100. FIG. 7B is a diagram showing a second example in which operation screen WD1b of the card settlement application executable in transaction equipment 100 is displayed on touch panel TP2 of transaction equipment 100.

On operation screen WD1a shown in FIG. 7A, a card brand of a card used in the settlement of the commercial transaction is displayed such that the salesperson can select the card brand from “MESPOR”, “VOJA”, . . . , and a card number, an expiration date of the card, a settlement amount of money of the commercial transaction, a payment method as a settlement method of the card, and the number of payments are displayed. If the number of payments is input, an item “next” is input through the touch, and an input screen of settlement information (for example, a PIN as authentication information) which is subsequently input is displayed.

On operation screen WD1b shown in FIG. 7B, an input area for inputting the authentication information (for example, the PIN) for authenticating the customer as a legitimate owner of the card in addition to screen operation WD1a shown in FIG. 7A. On the operation screen shown in FIG. 7B, a card brand “MESPOR” is already selected; a card number “xxxx-xxxx-xxxx-3456” and an expiration data thereof (is not displayed after the card number and the expiration data are input) are input, and the payment amount of money and “lum-sum payment” as the payment method are input.

For example, in a case where the PIN is input as the authentication information for authenticating the customer as the legitimate owner of the card, transaction equipment 100 transmits the authorization inquiry of the settlement process including the card brand, the card number, the expiration data, the amount of money, the payment method, the number of payments, and the PIN to settlement server STLC through in a direct manner or in an indirect manner through docking device 200, in response to the input operation of the salesperson. In settlement server STLC, the determination (that is, the determination of whether or not to authorize the customer as a target of the settlement process) of the authorization inquiry is performed, and the determination result (for example, notification that the authorization is possible) of the authorization inquiry is transmitted to transaction equipment 100 from settlement server STLC in the direct manner or in the indirect manner through docking device 200. If the determination result (for example, notification that the authorization is possible) of the authorization inquiry is received, transaction equipment 100 transmits a process request for sales registration of the amount of money in the settlement process of the commercial transaction to settlement server STLC in the direct manner or the indirect manner through docking device 200. In settlement server STLC, a sales registration process is performed in response to the process request for the sales registration from transaction equipment 100, and the processing result of the sales registration is sent to transaction equipment 100. Thus, transaction equipment 100 can determine that the settlement process related to one commercial transaction is normally ended in the settlement application.

### Example of Operation Screen of Merchandise Registration Application

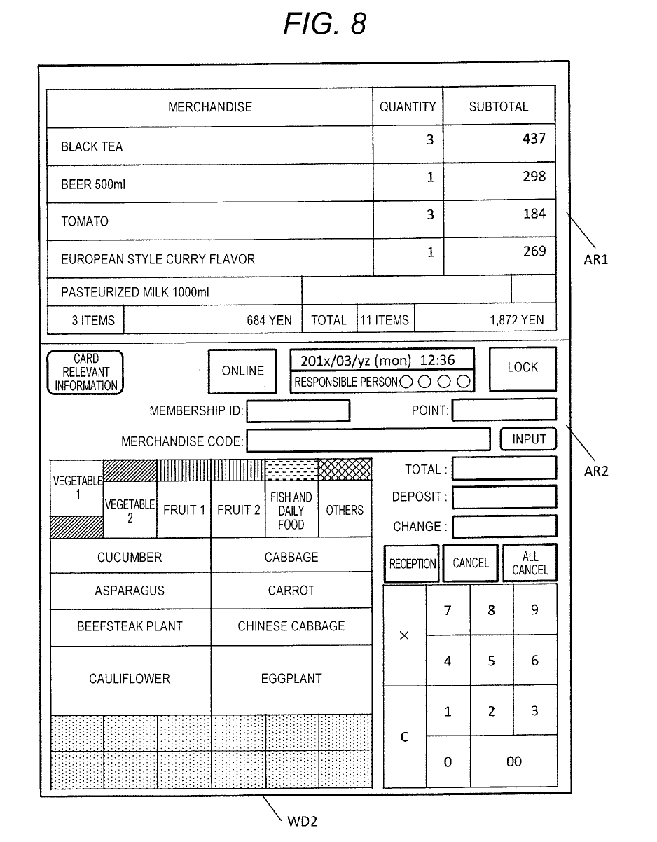

Hereinafter, operation screen WD2 of the merchandise registration application (that is, an application for registering the quantities or items of the services or merchandises as sales targets in a database inside or outside the store) installed in transaction equipment 100 will be described with reference to FIG. 8. FIG. 8 is a diagram showing an example in which operation screen WD2 of the merchandise registration application executable in transaction equipment 100 is displayed on touch panel TP2 of transaction equipment 100.

Operation screen WD2 shown in FIG. 8 includes an item and quantity display area AR2 for inputting the items and quantities of the merchandises or services as sales targets, and a registering target list display area AR1 for displaying the item, quantity and subtotal (that is, the product of the unit price and quantity of merchandises or services) of the merchandises or services input in item and quantity display area AR2 and the total amount of money (that is, the payment amount of money of the customer) related to the settlement (for example, a cash settlement or a card settlement) of the commercial transaction.

Transaction equipment 100 displays operation screen WD2 on internal display 34b shown in FIG. 8 after the merchandise registration application is started. For example, in a case where the customer purchases “three black tea products”. “one can of 500-ml beer”. “three tomatoes”, “one European style curry flavor” and “three cartons of 1000-ml pasteurized milk”, the salesperson sequentially inputs combinations of the items and quantities of the merchandises as sales targets on item and quantity display area AR2 of operation screen WD2 displayed on internal display 34b through the touch. For example, the salesperson may input the items and quantities of all the merchandises by reading barcodes assigned to the merchandises by means of barcode reader 800 even though the salesperson does not perform the touch input. If the input of the items and quantities of all the merchandises is ended, transaction equipment 100 displays the merchandises as sales targets, the quantities of the merchandises, and the payment amount of money on registering target list display area AR1 of operation screen WD2 displayed on internal display 34b. Thus, during the execution of the merchandise registration application, transaction equipment 100 can register the services or merchandises as sales targets, and the quantities and the total amount of money thereof in correlation with a sales date and identification information (for example, the name of the salesperson) regarding the salesperson in response to the operation on operation screen WD2 shown in FIG. 8.

Description of Operation when Transaction Equipment is Detached from Docking Device

Hereinafter, the operation when transaction equipment 100 is detached from docking device 200 will be described. In a case where the transaction equipment is detached from docking device 200, it is possible to detach transaction equipment 100 by performing a predetermined procedure in order to ensure security.

An example of a predetermined procedure when transaction equipment 100 is detached from docking device 200 will be described.

(1) In transaction equipment 100, a series of transaction processes are completed by predetermined applications. For example, the merchandise registration process using the merchandise registration application, the card settlement process using the card settlement application and the cash settlement process using the cash settlement application are completed.

(2) The predetermined application of transaction equipment 100 such as the application in which the process is completed is ended. It is assumed that the predetermined application is ended in a case where a user management application is started.

(3) Cash drawer 400 is closed. Cash drawer 400 is closed in a case where the cash drawer is open, and is maintained in a closed state in a case where the cash drawer is closed.

(4) The power-supplies of the predetermined peripheral equipments such as receipt printer 300 and external display 500 are turned off.

(5) In transaction equipment 100, the user who has logged on logs out.

(6) Locking part J2 of docking device 200 is unlocked.

As stated above, after the completion of the predetermined transaction process, the end of the application, the closed state of cash drawer 400 and the log-out of the user are performed and locking part J2 of docking device 200 is unlocked, transaction equipment 100 is detached from equipment holder ECP. The user such as the salesperson can freely carry transaction equipment 100 as independent equipment, and can perform the processes of various applications such as merchandise registration, settlement and inventory in an appropriate place.

### Procedure of Notification Operation

In transaction processing system 1000 used while portable transaction equipment 100 is attached to docking device 200, there is a high risk of the loss, information leak or unauthorized operation of transaction equipment 100 capable of being freely carried. Portions to be subject to handiwork for degrading security are present in portable transaction equipment 100, and thus, there is a concern that the handiwork will be performed such that an alert is not produced. In portable transaction equipment 100, in a case where defects occur, for example, transaction equipment 100 is damaged, the battery is detached and the unauthorized operation is performed, there is a problem that the alert operation is stopped in the notification function of transaction equipment 100. Thus, it is difficult for a user (an employee of the store or a person in charge of the store) or a manager (a manager (owner) of the store) of transaction processing system 1000, or a manager (an issuer or an acquirer) of a settlement system to notify that the defects occur in some cases.

In the present exemplary embodiment, an example in which in transaction processing system 1000, docking device 200 which is a stationary device performs notification such as an alert in a case where the defects such as the unauthorized operation on transaction equipment 100 occur will be described.

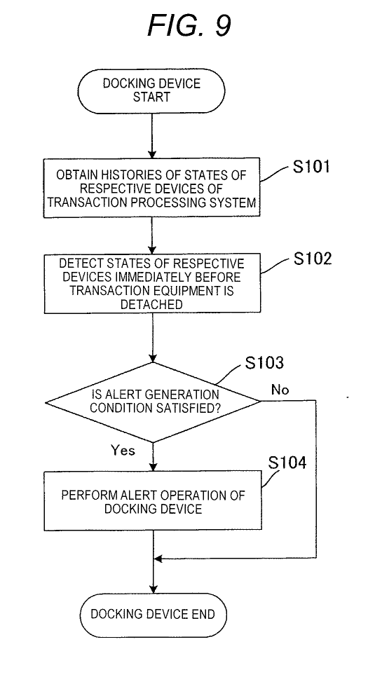

FIG. 9 is a flowchart for describing an example of a process of the notification operation in docking device 200 of the present exemplary embodiment. Docking device 200 sends an instruction to the device having the notification function through the process of CPU 51 with internal memory, and performs the notification operation.

CPU 51 with internal memory of docking device 200 communicates with transaction equipment 100, and checks the assignment of transaction equipment 100 and another peripheral equipment in transaction processing system 1000. CPU 51 with internal memory obtains the states of the respective devices for the respective devices including transaction equipment 100 and the peripheral equipment assigned to own device, and stores histories of states in memory 51m (step S101). Accordingly, the histories of the states of the respective devices of transaction processing system 1000 are stored in memory 51m. As the state of the device, at least one of a state of the application of transaction equipment 100, the exchange (a connection state or a communication state) between docking device 200 and transaction equipment 100, a state of the peripheral equipment such as cash drawer 400, and a state of locking part J2 of docking device 200 is used. That is, as the state of the device, any one state or a combination of the plurality of states is used.

Subsequently, in a case where transaction equipment 100 is detached from docking device 200, CPU 51 with internal memory of docking device 200 detects the state of the respective devices immediately before transaction equipment 100 is detached (step S102). CPU 51 with internal memory determines whether or not the alert generation condition is satisfied by using a combination of two or more states of the histories of the states of the respective devices obtained in steps S101 and S102 and the states of the respective devices immediately before transaction equipment 100 is detached or a single state (step S103).

As the alert generation condition, there are (1) a condition in which transaction equipment 100 is detached from docking device 200 without performing the predetermined procedure (the unauthorized detachment of transaction equipment 100 such as the detachment without unlocking locking part J2 of docking device 200), (2) a condition in which data wiring is detached between docking device 200 and the peripheral equipment without performing the predetermined procedure (the unauthorized detachment of the wiring between the docking device and the peripheral equipment), (3) a condition in which there is no reply from predetermined peripheral equipment corresponding to the application of transaction equipment 100 during the operation of the application, (4) a condition in which rubbery notification button RSW is pushed, and (5) a condition in which an unauthorized open operation (breaking open the cash drawer, or an open operation which is not relevant to the cash settlement) of cash drawer 400 occurs.

In step S103, in a case where the alert generation condition is satisfied, CPU 51 with internal memory of docking device 200 performs the alert operation as the notification operation for notifying of the defect (step S104). As an example of the alert operation, there are the turning-on, blinking and rotating of LED lamp L1 (alert lamp) of docking device 200 or the production of the alert sound from speaker S1 of docking device 200. As another example of the alert operation, there are the alert indication on external display 500, the alert indication on customer display 550, the alert indication on transaction equipment 100, and the transmission of the alert information to monitoring center device MC or settlement server STLC through network NW or another device. The rubbery notification is displayed on only external display 500 facing the salesperson, and is not displayed on customer display 550 facing the customer. As the alert operation, at least one of a plurality of operations in the above-described example may be performed.

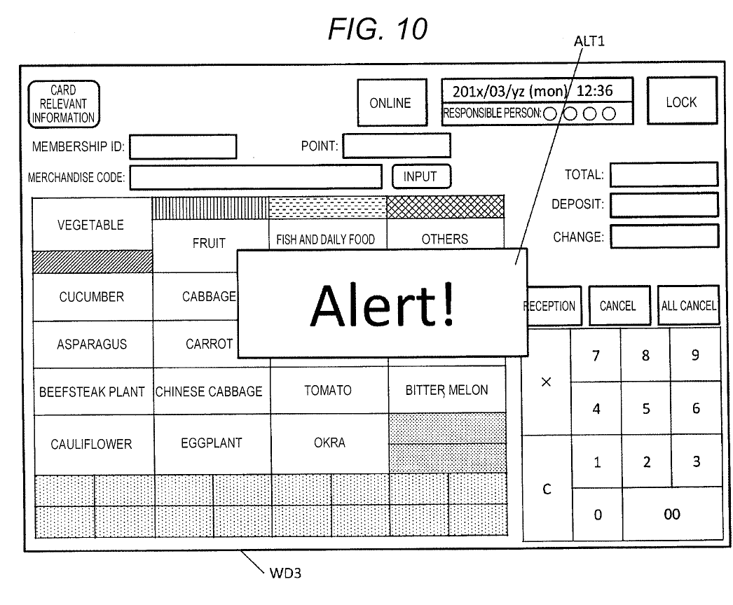

For example, in a case where the notification is performed by another device through the performing of the alert operation of docking device 200, a notification instruction is transmitted to external display 500 and transaction equipment 100 from docking device 200. In a case where the notification instruction is received from docking device 200, external display 500 or transaction equipment 100 displays the alert on the display screen of the monitor (see FIG. 10). In a case where the emitting of the alert lamp or the generation of the alert sound is performed in docking device 200, LED lamp L1 of docking device 200 is turned on, and the alert sound is output from speaker S1 (see FIG. 2). In a case where the alert information is transmitted to another device, the alert information is notified by being transmitted to monitoring center device MC and settlement server STLC from docking device 200 (see FIG. 1).

FIG. 10 is a diagram showing an example of the alert indication displayed on external display 500 or transaction equipment 100. In a case where the alert indication is performed in another device, docking device 200 transmits the notification instruction to external display 500 or transaction equipment 100, and displays the alert indication. In external display 500 or transaction equipment 100, alert indication ALT1 such as “Alert!” is displayed on display screen WD3 of the monitor.

As mentioned above, in the present exemplary embodiment, the handiwork for degrading security is not easily performed in transaction processing system 1000 using portable transaction equipment 100, and the alert is generated from docking device 200 as a device to which the power-supply is continuously supplied. Thus, the arrival accuracy of the alert becomes high. Thus, the user or manager of transaction processing system 1000 can rapidly detect the notification for notifying of the defect, and can more accurately detect the notification. Accordingly, it is possible to increase the effect of preventing the loss in transaction equipment 1000.

In docking device 200 of the present exemplary embodiment, portable transaction equipment 100 capable of executing at least one of the settlement application and the business application (for example, the merchandise registration application and the stock management application) can be attached and detached. Docking device 200 includes equipment holder ECP that holds transaction equipment 100, device authentication controller 63 that detects the attachment of transaction equipment 100 to equipment holder ECP, lock determination part J1, and CPU 51 with internal memory that performs the notification operation for notifying of the occurrence of the defect in a case where the predetermined alert generation condition is satisfied when transaction equipment 100 is detached from equipment holder ECP.

Accordingly, in transaction processing system 1000 using portable transaction equipment 100, it is possible to perform the notification such as the alert by stationary docking device 200, and thus, it is possible to improve the arrival accuracy of the notification. Thus, it is possible to improve a possibility that the notification will be detected by reducing time necessary for the user or manager of transaction processing system 1000 to detect the notification, and it is possible to increase the effect of preventing the loss in transaction processing system 1000.

In docking device 200 of the present exemplary embodiment, CPU 51 with internal memory obtains at least one of the histories of the states of the respective devices of transaction processing system 1000 including own device and the states of the respective devices immediately before transaction equipment 100 is detached, and performs the notification operation in a case where the predetermined alert generation condition in the obtained state.

Therefore, the determination may be performed using the detachment of transaction equipment 100 from docking device 200 without performing the predetermined procedure, the detachment of the data wiring between docking device 200 and the peripheral equipment without performing the predetermined procedure and the performing of the unauthorized open operation of cash drawer 400 as the alert generation condition.

In docking device 200 of the present exemplary embodiment, CPU 51 with internal memory performs the notification operation in a case where at least one state of the detachment of transaction equipment 100 from the own device without performing the predetermined procedure, the detachment of the data wiring between the own device and another device of transaction processing system 1000 without performing the predetermined procedure and the occurrence of the unauthorized open operation of cash drawer 400 in transaction processing system 1000 occurs.

Accordingly, it is possible to accurately perform the notification such as the alert in a case where transaction equipment 100 is detached from docking device 200 without performing the predetermined procedure, in a case where the data wiring is detached between docking device 200 and the peripheral equipment without performing the predetermined procedure, and in a case where the unauthorized open operation of cash drawer 400 is performed.

Transaction processing system 1000 of the present exemplary embodiment includes portable transaction equipment 100 that is capable of executing at least one of the settlement application and the business application, and docking device 200 that is connected to at least one peripheral equipment used in the settlement application or the business application and is capable of being attached to and detached from transaction equipment 100. Docking device 200 detects the attachment of transaction equipment 100 to equipment holder ECP which holds transaction equipment 100 through device authentication controller 63 and lock determination part J1, and performs the notification operation for notifying of the occurrence of the defect in a case where the predetermined alert generation condition is satisfied when transaction equipment 100 is detached from equipment holder ECP.

Docking device 200 of the present exemplary embodiment detects the attachment of transaction equipment 100 to equipment holder ECP which holds transaction equipment 100 through device authentication controller 63 and lock determination part J1, and performs the notification operation for notifying of the occurrence of the defect in a case where the predetermined alert generation condition is satisfied by controlling CPU 51 with internal memory when transaction equipment 100 is detached from equipment holder ECP.

While the exemplary embodiments of the transaction processing system according to the present disclosure have been described with reference to the accompanying, the present disclosure is not limited to the exemplary embodiments. It will be apparent to those skilled in the art that various changes, modifications, substitutions, additions, deletions and their equivalents may be made without departing from the claims, and would fall within the technical scope of the present disclosure.

It has been described in the above-described present exemplary embodiment that a settlement process using a credit card (more specifically, a magnetic credit card, connect IC credit card, or non-contact IC credit card) is used as an example of a card transaction of a purchaser, but the present disclosure is not limited to the settlement process using the credit card. For example, the present disclosure may be applied to a settlement process using a debit card, electronic money, a prepaid card, a postpaid card, a point card, an electronic coupon, or an electronic merchandise certificate.

What is claimed is:

1. A docking device that is capable of being attached to and detached from portable transaction equipment capable of executing at least one of a settlement application and a business application, the device comprising:
an equipment holder that holds the transaction equipment;
an attachment detector that detects the attachment of the transaction equipment to the equipment holder; and
a controller that performs a notification operation for notifying of the occurrence of a defect in a case where a predetermined alert generation condition is satisfied when the transaction equipment is detached from the equipment holder.

2. The docking device according to claim 1,
wherein the controller obtains at least one of histories of states of the respective devices of a transaction processing system including the own device and states of the respective devices immediately before the transaction equipment is detached, and performs the notification operation in a case where the predetermined alert generation condition is satisfied in the obtained state.

3. The docking device according to claim 2,
wherein the controller performs the notification operation in a case where at least one state of a state in which the transaction equipment is detached from the own device without performing a predetermined procedure, a state in which data wiring is detached between the own device and another device of the transaction processing system without performing a predetermined procedure, and a state in which an unauthorized open operation of a cash drawer in the transaction processing system is performed occurs.

4. A transaction processing system comprising:
portable transaction equipment that is capable of executing at least one of a settlement application and a business application; and
a docking device that is connected to at least one peripheral equipment used in the settlement application or the business application, and is capable of being attached to and detached from the transaction equipment,
wherein the docking device detects the attachment of the transaction equipment to an equipment holder that holds the transaction equipment by an attachment detector, and performs a notification operation for notifying of the occurrence of a defect in a case where a predetermined alert generation condition is satisfied when the transaction equipment is detached from the equipment holder.

5. A notification method in a docking device capable of being attached to and detached from portable transaction equipment capable of executing at least one of a settlement application and a business application, the method comprising:
causing an attachment detector to detect the attachment of the transaction equipment to an equipment holder of the docking device which holds the transaction equipment; and
performing a notification operation for notifying of the occurrence of a defect in a case where a predetermined alert generation condition is satisfied under the control of a controller when the transaction equipment is detached from the equipment holder.
